(19) United States
(12) Patent Application Publication
(10) Pub. No.: US 2006/0272691 A1
(43) Pub. Date: Dec. 7, 2006

(54) Walker boot for walkers

(76) Inventor: Carl Evans DeLesline, Fayetteville, GA (US)

Correspondence Address: Carl E. DeLesline, 3501 Cobblestone Boulevard, Fayetteville, GA, 30215, US

(21) Appl. No.: 11/143,619

(22) Filed: Jun. 3, 2005

(51) Int. Cl. A45B 9/04; A61H 3/00

(52) U.S. Cl. 135/67; 135/77; 135/86

(57) ABSTRACT

A walker boot for a walker of the type that has four legs that extend into contact with the ground and support an upper handgrip portion 2. The walker boot encompasses the bottom portion of at least one of the legs of the walker 1. The walker boot has a surface of solid elastic matted fibers such that any vibration, friction or noise caused by moving the walker boot across a hard surface is dampened. The inner portion of the walker boot has a metal insert 5 above the bottom portion of the boot to prevent the walker leg from engaging friction with the underlying surface and to prevent abrading.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to walker tips which are used to fit on the bottom back legs of a walker that is used to assist the elderly and physically impaired in walking

2. Background of the Invention

Walkers are widely known in hospitals and nursing facilities, and are comprised of a metal frame that has two sides each having a pair of parallel legs that extend to the ground or floor generally at the corners of a rectangle. Thus, defining two front legs and two rear legs. The two side frames each have a portion that is adjacent to an upper part of the frame so that the user's hands rest upon the upper part allowing the user to move the frame forward and take steps, to assist in walking.

The walker has wheels mounted on each of the front legs and rubber tips mounted on each of the rear legs. The frame is moved by sliding the rear legs across the underlying surface while the wheels on the front provide a rolling motion.

The act of sliding the walker creates a chirping noise and vibrations that are transmitted to the hands and arms of the user causing the user to desire to lift the walker between each set of steps. The noise and vibrations are caused by the friction of the rubber tip on a smooth hard surface, such that is found in hospitals and nursing homes. This problem creates a great desire and need to solve the noise and vibration caused by using a walker in this manner.

A temporary solution to the problem involves creating a hole in a tennis ball and inserting a leg into it. This seems to be a desirable solution, however the outer surface of the tennis ball wears out and the chirping noise returns. Another solution involves removing the rubber tip and replacing it with a hard plastic tip. This solution has proven unsatisfactory in that it is inconvenient for the user and the plastic tip wears and becomes rough, thus allowing the chirping noise to return with increased friction and possibly allowing the metal leg to be exposed and causing it to abrade. A third solution involves using a glide cap that slides over a portion of the rubber tip. This solution, too, is unsatisfactory in that the tip wears completely and the chirping noise returns.

### SUMMARY OF THE INVENTION

The present invention solves the aforementioned problems by providing a walker tip that replaces the rubber tip presently provided on walkers. The walker tip is made from a durable wear resistant material and has a bottom surface with a hardness that is greater than the hardness of the existing rubber tip. The tendency of the walker to make chirping noises is reduced because the friction of the walker tip is less than the friction of the rubber tip, thus eliminating the need for a glide cap or any additional attachments. When additional friction is desired, the walker tip can be removed and be replaced with the rubber tip.

### DRAWING FIGURES

In the drawings, each figure has numbers specifying each part of the walker boot.

FIG. 1 shows a walker with the walker boot in position.

FIG. 2 shows the details of the walker boot's interior and exterior makings.

FIG. 3 shows the walker boot's total embodiment.

### DRAWINGS—REFERENCE NUMERALS

1—Walker boot
2—Rear of walker
3—Open top rubber lining
4—Upward wall extension
5—Metal stop
6—Bottom surface

### DETAILED DESCRIPTION

A complete embodiment of the walker boot is shown in FIG. 3. The boot has a rubber lining 3 adapted to encompass a walker leg. It extends one-fourth of an inch further than the wool felt outer covering. The boot has a rounded bottom 6 adapted for engagement with any underlying surface. The boot also has an upward wall extension 4 which surrounds a walker leg and has an open top that allows the rubber lining to extend one-fourth of an inch further.

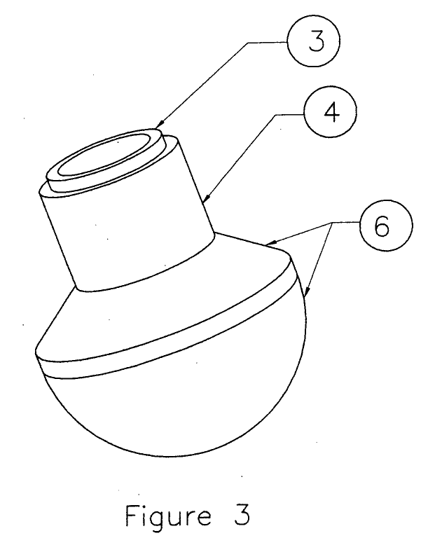

The inner makings of the boot is shown in FIG. 2. The rubber lining 3 adapted to encompass a walker leg covers the entire interior wall of the boot. A metal insert 5 is placed above the rounded bottom to prevent the walker leg from engaging friction with the bottom and to prevent abrading.

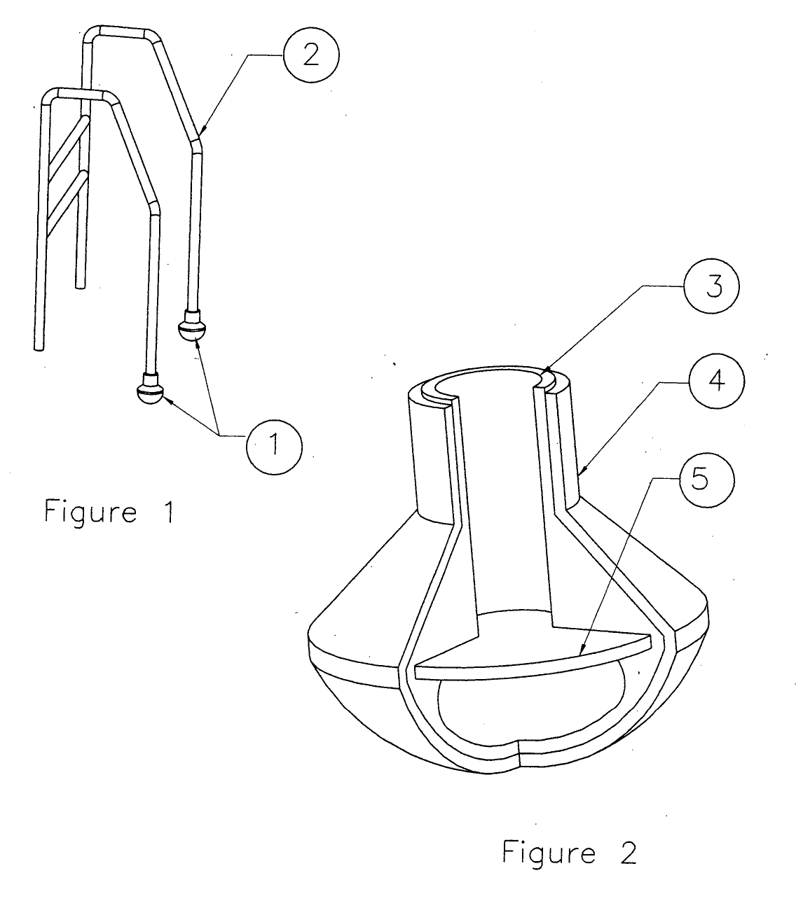

The actual position of the walker boot is shown in FIG. 1. The rear of the walker 2 slides across the underlying surface and the walker boot 1 is placed on the legs to prevent friction and vibration.

Conclusion, Ramifications, and Scope

Accordingly, the reader will see that the walker boot of this invention can be easily used by anyone that uses a walker for assistance in walking. The boot can be used to decrease the effort in moving a walker which is an advantage for elderly patients who have not the strength to lift a walker. The walker boot can also bring relief to nurses and caregivers who assist patients in the usage of walkers.

Thus, the scope of this invention should be determined by the claims given and their legal equivalents.

I claim:

1. In combination with a walker having a pair of front legs and a pair of rear legs, the legs terminating at a lower end, at least one walker boot comprising of a surface removably secured to the bottom of the terminal end of at least one of the legs wherein said walker boot is formed from a material having a hardness lesser than the hardness of the legs.

2. The walker of claim 1 wherein the walker boot has a coefficient of friction less than the coefficient of friction of the leg.

3. The walker of claim 1 wherein the terminal end of each rear leg is provided with a walker boot.

4. A removable walker boot is adapted for installation on the terminal end of a leg on a walker, said walker boot comprising
a. a bottom surface formed from a material having a hardness lesser that the hardness of the leg and having a coefficient of friction less than the coefficient of friction of the leg, and
b. at least one wall extending upward from said bottom surface to define an open top sized to surround and to frictionally engage a leg when a leg is inserted into said open top, wherein the walker boot bottom surface is adapted to engage an underlying support surface for a walker leg.

5. The walker boot of claim 4, wherein at least one wall extending upwardly from said bottom surface has an interior surface adapted to encompass a walker leg.

6. The walker boot of claim 4, wherein the boot is formed from a rubber.

7. The walker boot of claim 4, wherein the boot is formed from wool felt.

8. A walker having a pair of front legs and a pair of rear legs, each leg terminating at a lower terminal end, the improvement comprising at least one removable walker boot having a surface adapted for engagement with an underlying supporting surface for the walker and at least one wall extending upward from bottom surface to define an open top which surround and frictionally engages said legs, wherein walker boot is removably engaged with leg.
